(19) United States
(12) Patent Application Publication
(10) Pub. No.: US 2008/0285160 A1
(43) Pub. Date: Nov. 20, 2008

(54) PROJECTION LENS

(75) Inventors: Ihar Shyshkin, Suwon-si (KR); Koan-Young Oh, Yongin-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 12/114,487

(22) Filed: May 2, 2008

(30) Foreign Application Priority Data
May 4, 2007 (KR) 10-2007-0043700

(51) Int. Cl. G02B 27/18; G02B 9/06

(52) U.S. Cl. 359/794; 359/738

(57) ABSTRACT

A projection lens for magnifying and projecting input light on a screen is disclosed. The projection lens in accordance with an embodiment of the present invention includes: a first lens having a positive refractive power; a second lens having a negative refractive power and receiving the light that has passed through the first lens; and a third lens combined with the second lens to form a lens group having a positive refractive power and receiving the light that has passed through the second lens and projecting the light on the screen separated by a predetermined length from the lens group.

### CROSS-REFERENCE TO RELATED APPLICATIONS

This application claims the benefit of Korean Patent Application No. 10-2007-0043700, filed with the Korean Intellectual Property Office on May 4, 2007, the disclosure of which is incorporated herein by reference in its entirety.

### BACKGROUND OF THE INVENTION

1. Field of the Invention

The present invention relates to a projection apparatus (module), more particularly to a projection lens used for receiving a reflected light from an optical modulator and magnifying and projecting the reflected light on a screen.

2. Description of the Related Art

With the recent development of display technologies, there has been increasing demand for small-sized display devices, for example, Personal Digital Assistants (PDA) and Portable Multimedia Players (PMP), as well as large-sized display devices such as TV sets and monitors. In particular, since display devices to which a projection method is applied are not only more suitable for implementing a large scale image than other large-sized display devices, for example, CRT TV, LCD TV and PDP TV, but also are competitive in price, they are very popular among consumers.

However, because display devices with a conventional projection method require many, complicated components (e.g., a light source, mirrors, optical lenses and projection lenses) as well as ample distance between components or for projection to implement an image, it has been difficult to apply the conventional projection method to a small-sized display device. That is, realizing a compact projection type display device has been hampered by the above restrictions of the conventional technology.

### SUMMARY OF THE INVENTION

The present invention provides a projection lens with a significantly smaller size and volume by simplifying and compacting the configuration of the projection lens.

The present invention also provides a projection lens that can be used in small-sized digital devices, such as a mobile phone and/or a PMP, as well as large-sized display devices.

Moreover, the present invention provides a projection lens having better performance of projection (i.e., MTF characteristics, ray aberration, field curvature, distortion aberration, etc.).

An aspect of the present invention features a projection lens that magnifies and projects inputted light on a screen. The projection lens in accordance with an embodiment of the present invention can include: a first lens, configured to have a positive refractive power; a second lens, configured to have a negative refractive power and receive the light that has passed through the first lens; and a third lens, configured to be combined with the second lens to form a lens group having a positive refractive power and receive the light that has passed through the second lens and project the light on the screen separated by a predetermined length from the lens group.

The first lens can receive light transmitted from an optical modulator, and the relation between a length (Bf) from a rear surface of the first lens to the optical modulator and a focal length (f) of the projection lens can satisfy Bf>0.25f.

The relation between a projection distance (Pd) of the projection lens and the focal length (f) of the projection lens can satisfy Pd>20f.

The relation between a field of view (Fov) of the projection lens and the focal length (f) of the projection lens can satisfy Fov>0.4f.

An f-number (Fn) of the projection lens can satisfy Fn>4.

The relation between a total length (T1) of the projection lens and the focal length (f) of the projection lens can satisfy T1<1.42f.

The relation between a focal length (f_{G}) of the lens group and the focal length (f) of the projection lens can satisfy 0.68<f/f_{G}<0.72.

The relation between a focal length (f₁) of the first lens and the focal length (f) of the projection lens can satisfy 1.14<f/f₁<1.24.

An average value (N₃) of the index of refraction of the third lens can satisfy 1.8<N₃<2.

An average value (V₃) of an Abbe number of the third lens can satisfy 30<V₃<45.

Another aspect of the present invention features a projection lens system, configured to magnify and project inputted light on a screen. The projection lens system in accordance with an embodiment of the present invention can include: a projection lens; and an aperture stop, located between the projection lens and the screen and configured to transmit light projected from the projection lens. The projection lens can include: a first lens, configured to have a positive refractive power; a second lens, configured to have a negative refractive power and receive the light that has passed through the first lens; and a third lens, configured to be combined with the second lens to form a lens group having a positive refractive power and receive the light that has passed through the second lens.

The relation between an entrance pupil (Ep) of the aperture stop and a focal length (f) of the projection lens can satisfy Ep>0.25f.

### BRIEF DESCRIPTION OF THE DRAWINGS

FIG. 1 illustrates the configuration of a projection lens according to an embodiment of the present invention.

FIG. 2 shows an example of how the projection lens illustrated in FIG. 1 is implemented.

FIG. 3A shows an example of actual implementation data of the projection lens according to an embodiment of the present invention.

FIG. 3B shows another example of actual implementation data of the projection lens according to an embodiment of the present invention.

FIG. 4A to FIG. 4C illustrate ray aberration in the projection lens according to the actual implementation data of FIG. 3A.

FIG. 5A to FIG. 5C illustrate ray aberration in the projection lens according to the actual implementation data of FIG. 3B.

FIG. 6A illustrates field curvature and distortion aberration in the projection lens according to the actual implementation data of FIG. 3A.

FIG. 6B illustrates field curvature and distortion aberration in the projection lens according to the actual implementation data of FIG. 3B.

FIG. 7A illustrates MTF characteristics of the projection lens according to the actual implementation data of FIG. 3A.

FIG. 7B illustrates MTF characteristics of the projection lens according to the actual implementation data of FIG. 3B.

### DETAILED DESCRIPTION OF THE EXEMPLARY EMBODIMENT

Hereinafter, a projection lens in accordance with some embodiments will be described in detail with reference to the accompanying drawings. Identical or corresponding elements will be given the same reference numerals, regardless of the figure number, and any redundant description of the identical or corresponding elements will not be repeated. Throughout the description of the present invention, when describing a certain technology is determined to evade the point of the present invention, the pertinent detailed description will be omitted.

When one element is described as being “inputted” or “projected” to another element, it shall be construed as being connected or accessed to the other element directly but also as possibly having another element in between. On the other hand, if one element is described as being “directly inputted” or “directly projected” to another element, it shall be construed that there is no other element in between.

The terms used in the description are intended to describe certain embodiments only, and shall by no means restrict the present invention. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

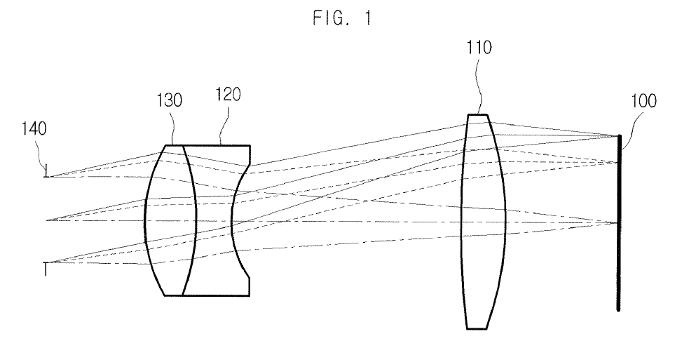

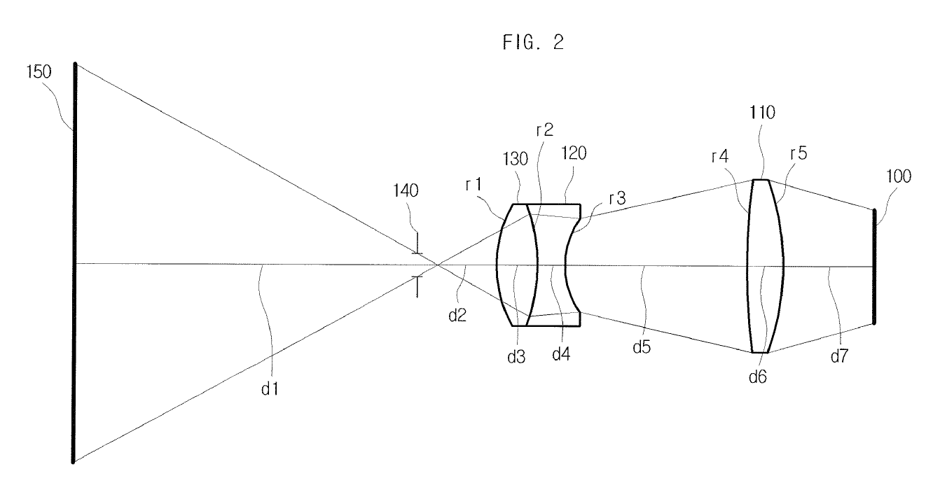

FIG. 1 illustrates a configuration of a projection lens according to an embodiment of the present invention. FIG. 2 shows an example of how the projection lens illustrated in FIG. 1 is implemented. Here, FIG. 1 simply illustrates an example of three incident beams projected, for the convenience of illustrating the drawing.

Referring to FIGS. 1 and 2, a projection lens according to an embodiment of the present invention includes a first lens 110, a second lens 120 and a third lens 130. Here, the second lens 120 and the third lens 130 can be combined together to form one lens group.

The first lens 110 has a positive refractive power and receives light reflected from an optical modulator 100. Here, that the lens has a positive refractive power signifies that an emission angle of the light inputted to the lens is reduced after passing through the lens. On the other hand, that the lens has a negative refractive power indicates that the emission angle of the light inputted to the lens is increased after passing through the lens. The lens having a positive refractive power (e.g., a convex lens) can be used for focusing the light, and the lens having a negative refractive power (e.g., a concave lens) can be used for diffusing the light.

The projection lens of the present invention can be designed in such a manner that the relation between a length from the rear surface of the first lens 110 to the optical modulator 100 (hereinafter, referred to as Back focal length, Bf) and an overall focal length (f) of the projection lens is described as Bf>0.25f.

The projection lens of the present invention can be also designed in such a manner that the relation between a focal length of the first lens 110 (f₁) and the overall focal length (f) of the projection lens is described as 1.14<f/f₁<1.24.

The optical modulator 100 receives light irradiated from a light source and modulates the light in accordance with predetermined light intensity information to generate diffraction light (that is, modulation light). The optical modulator can be applied to the present invention without any restriction, irrespective of the shape and type. The light intensity information mentioned above refers to information for each colored light in relation to color images to be actually implemented on a screen 150. The optical modulator 100 is well known by those skilled in the art without any additional description, and thus detailed description of the structure or the principle of optical modulation will be omitted herein.

The second lens 120 has a negative refractive power and receives light that has passed through the first lens 110. The third lens 130 has a positive refractive power and receives light that has passed through the second lens 120. Here, the second lens 120 and the third lens 130 come in contact with each other so that the two lenses form one lens group. The lens group formed by combination of the second lens 120 and the third lens 130 can be designed to have a positive refractive power as a whole. The light that has passed through both the second lens 120 and the third lens 130 is magnified and projected on the screen 150 located at a predetermined distance from the third lens 130.

The projection lens of the present invention can be designed in such a manner that a focal length (f_{G}) of the lens group formed through the combination of the second lens 120 and the third lens 130 and the overall focal length (f) of the projection lens have a relation of 0.68<f/f_{G}<0.72.

Here, an aperture stop 140 can be placed in front of the third lens 130 (that is, between the projection lens and the screen 150 of the present invention). The light that has passed through the third lens 130 is inputted to the aperture stop 140 so that the light can be magnified and projected on the screen 150 via the aperture stop 140. The projection lens and the aperture stop 140 of the present invention will be collectively referred to as a projection lens system, hereinafter. The projection lens system of the present invention can be designed in such a manner that an entrance pupil (Ep) of the aperture stop 140 and the overall focal length (f) of the projection lens satisfy a relation of Ep>0.25f.

The projection lens of the present invention can be also designed in such a manner that an average value (N₃) of the index of refraction of the third lens 130 is 1.8<N₃<2. The projection lens of the present invention can be also designed in such a manner that an average value (V₃) of an Abbe number of the third lens 130 is 30<V₃<45. The Abbe number quantitatively defines dispersion properties of the light in an optical lens. In general, the larger the Abbe number is, the less the light is dispersed, forming a clearer image. The Abbe number is used for a calculation of chromatic aberration compensation.

The projection lens of the present invention can be designed to satisfy a relationship of Pd>20f between a total projection distance (Pd) of the projection lens and the overall focal length (f). The projection lens of the present invention can be designed in such a manner that a field of view (Fov) of the projection lens and the overall focal length (f) can have a relation of Fov>0.4f. The projection lens of the present invention can be designed such that an f-number (Fn) of the projection lens is greater than 4, that is, Fn>4. The projection lens of the present invention can be also designed in such a manner that a total length (T1) of the projection lens and the overall focal length (f) of the projection lens satisfy a relation of T1<1.42f. Here, the f-number is one of units for representing the brightness of a lens, and is denoted by a value resulting from dividing the focal length of a corresponding lens with a diameter of light incident to the corresponding lens.

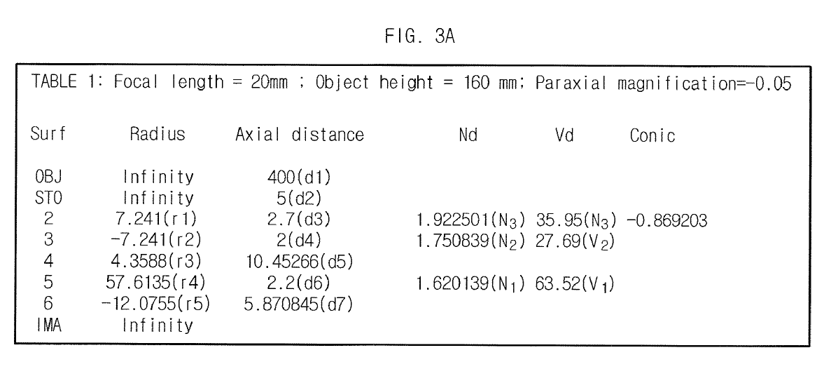

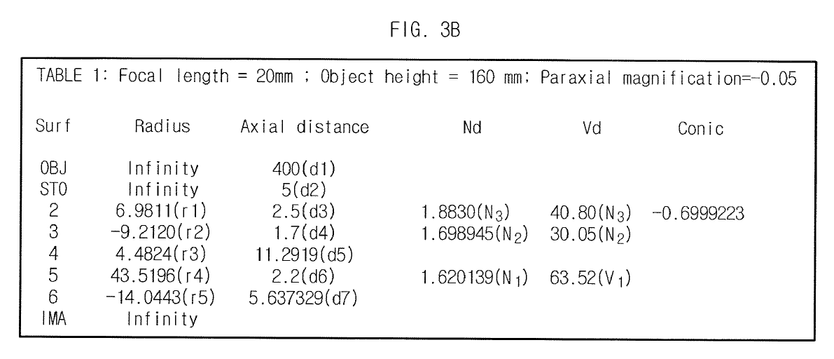

As described above, the size and volume of the projection lens of the present invention can be significantly reduced by simplifying and compacting the configuration, without sacrificing the projection performance (straightness, modulation transfer function (MTF) characteristic, ray aberration, field curvature, distortion aberration, etc.) of the projection lens. This will be more apparent through the following description with reference to FIG. 3A to FIG. 7B.

FIG. 3A shows an example of actual implementation data of the projection lens according to an embodiment of the present invention. FIG. 3B shows another example of actual implementation data of the projection lens according to an embodiment of the present invention. Hereinafter, the implementation data of FIG. 3A and 3B will be described with reference to FIG. 2.

In the table of FIG. 3A and 3B, “Radius” refers to data representing the radius of curvature of each part in the projection lens of the present invention, and “Axial distance” refers to data representing a distance from the optical axis of the projection lens to each part. “Nd” refers to data representing an index of refraction of each lens forming the projection lens of the present invention, and “Vd” refers to data representing an Abbe number of each lens forming the projection lens of the present invention. “Conic” refers to data representing a cone index of the light that has passed through the third lens 130.

In addition, the table describes an example of the overall focal length (f) (see “Focal length” in the table) of the projection lens being 20 mm and the height (see “Object height” in the table) of the screen 150 being 160 mm. The height of the optical modulator 100 of the table is 8 mm (that is, the screen height of 160 mm×paraxial magnification of 0.05). Here, “OBJ” refers to the screen 150 on which an object is magnified and projected through the projection lens of the present invention, and “STO” refers to the aperture stop 140 located between the screen 150 and the third lens 130 in the projection lens of the present invention. “IMA” refers to the optical modulator 100 which performs an optical modulation according to predetermined light intensity information.

The example of the projection lens of the present invention shown in FIG. 3A is designed with the following implementation data for each part. First, the radius of curvature of each of the screen 150 (that is, “OBJ” in the table), the aperture stop 140 (that is, “STO” in the table) and the optical modulator 100 (that is, “IMA” in the table) is infinity (that is, flat without curvature). The front surface of the third lens 130 has a radius of curvature (r1) of 7.241, the rear surface of the third lens 130 or the front surface of the second lens 120 a radius of curvature (r2) of −7.241, the rear surface of the second lens 120 a radius of curvature (r3) of 4.3588, the front surface of the first lens 110 a radius of curvature (r4) of 57.6135, and the rear surface of the first lens 110 a radius of curvature (r5) of −12.0755.

Next, a distance (d1) between the screen 150 and the aperture stop 140 is 400 mm, and a distance (d2) between the aperture stop 140 and the front surface of the third lens 130 is 5 mm. A distance (d3) between the front surface and the rear surface of the third lens 130 is 2.7 mm; a distance (d4) between the rear surface of the second lens 120 and either the rear surface of the third lens 130 or the front surface of the second lens 120 is 2 mm; a distance (d5) between the rear surface of the second lens 120 and the front surface of the first lens 110 is 10.45266 mm; a distance (d6) between the front surface and the rear surface of the first lens 110 is 2.2 mm; and a distance (d7) (that is, a back focal length, Bf) between the rear surface of the first lens 110 and the optical modulator 100 is 5.870845 mm. It should be noted that the projection lens of the present invention has the back focal length (Bf) that is approximately 0.294 times (that is, 5.870845/20) the overall focal length (f) of the projection lens, satisfying the relation of Bf>0.25f.

Referring to the index of refraction and Abbe number of each lens in the projection lens of the present invention, the first lens 110 has an index of refraction (N₁) and an Abbe number (V₁) of 1.620139 and 63.52, respectively, and the second lens 120 has an index of refraction (N₂) and an Abbe number (V₂) of 1.750839 and 29.69, respectively. The third lens 130 has an index of refraction (N₃) and an Abbe number (V₃) of 1.922501 and 35.95, respectively. It should be noted that the index of refraction (N₃) and the Abbe number (V₃) of the third lens 130 satisfy the relations of 1.8<N₃<2 and 30<V₃<45, respectively.

FIG. 3B can be understood in a similar manner to the description of FIG. 3A. Looking at some of the critical implementation data of FIG. 3B, the back focal length (Bf) (see d7 in FIG. 3B) in the projection lens of the present invention is approximately 0.282 times (that is, 5.637329/20) the overall focal length (f), satisfying the relation of Bf>0.25f. Further, the index of refraction (N₃) and the Abbe number (V₃) of the third lens 130 also satisfy the relations of 1.8<N₃<2 and 30<V₃<45, respectively.

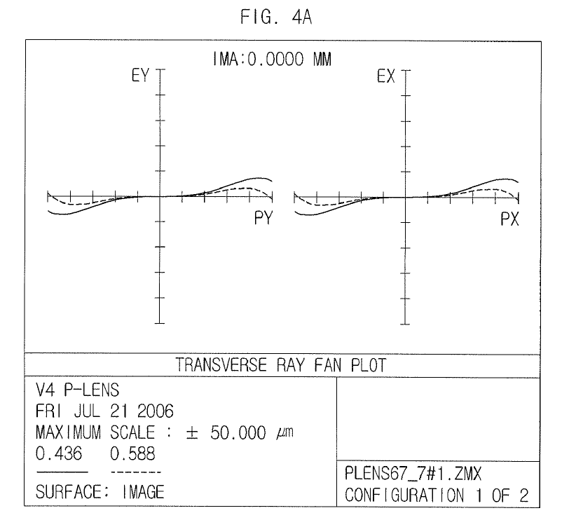

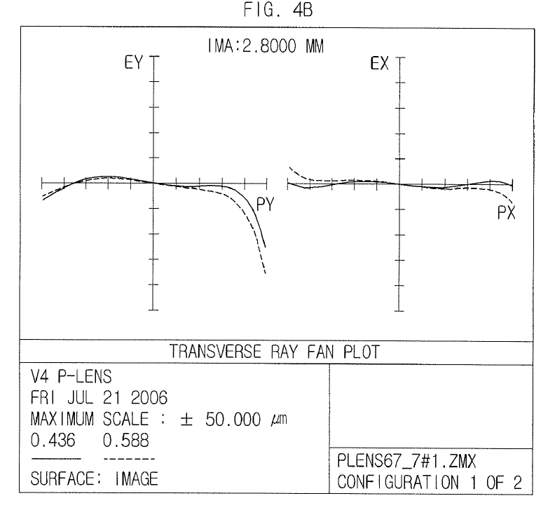

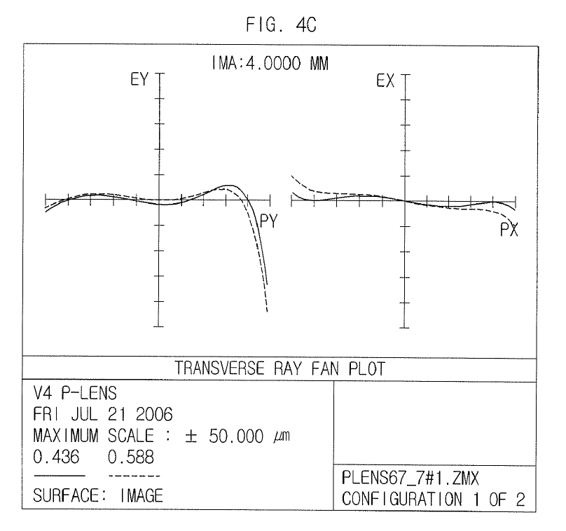

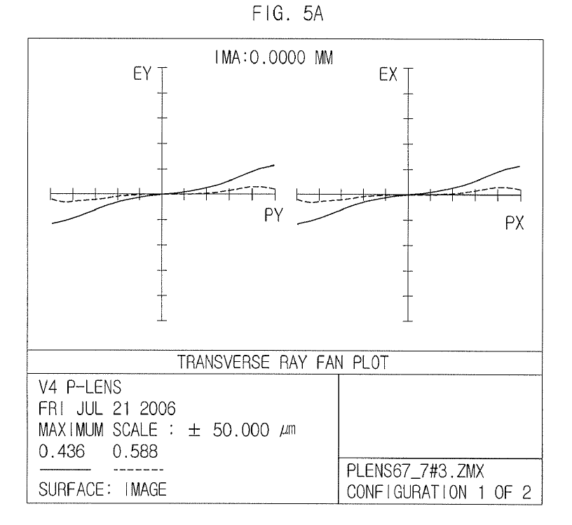

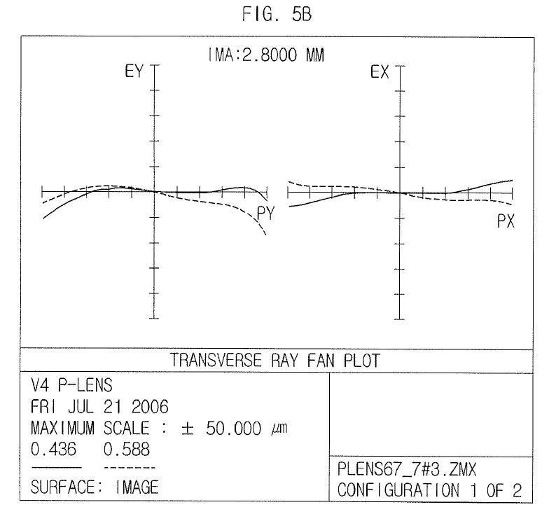

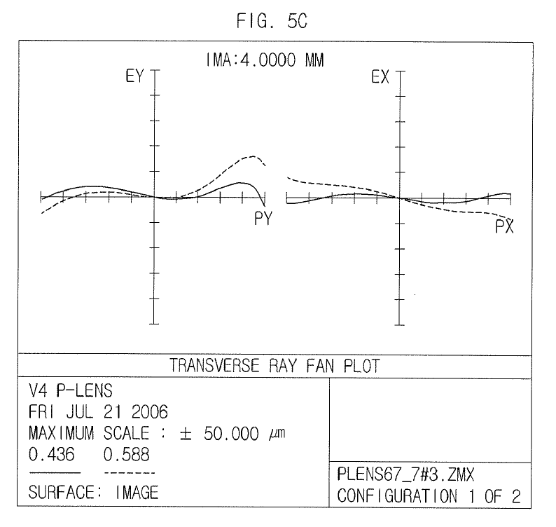

FIGS. 4A to 4C illustrate ray aberration in the projection lens according to the actual implementation data of FIG. 3A. FIG. 5A to FIG. 5C illustrate ray aberration in the projection lens according to the actual implementation data of FIG. 3B.

Here, FIG. 4A and FIG. 5A are graphs showing ray aberration when the light reflected from the midpoint on the optical modulator 100 passes through the projection lens of the present invention and is projected on the screen 150. FIG. 4B and FIG. 5B are graphs showing ray aberration when the light reflected from a point that is 2.9 mm apart from the midpoint on the optical modulator 100 passes through the projection lens of the present invention and is projected on the screen 150. FIG. 4C and FIG. 5C are graphs showing ray aberration when the light reflected from a point separated by 4 mm from the midpoint on the optical modulator 100 passes through the projection lens of the present invention and is projected on the screen 150.

In the graphs, solid lines indicate a fraunhofer line having a wavelength of 0.436□, and dotted lines indicate a fraunhofer line having a wavelength of 0.58858 . The horizontal axis in each graph represents a distance between the center of the aperture stop 140 and a point on which the light transmitted from the optical modulator 100 has passed through the aperture stop 140. The vertical axis of each graph represents ray aberration when the light transmitted from the optical modulator 100 is magnified and projected on the screen 150 by way of both the aperture stop 140 and the projection lens of the present invention.

Referring to each graph illustrated in FIGS. 4A to 4C and FIGS. 5A to 5C, it can be appreciated that the ray aberration in the projection lens of the present invention is about 10□ (that is, an approximate value of ⅕ of the maximum scale (50□) on the vertical axis of the graph). Considering that the size of one pixel in a typical projection system is between about 30□ and 50□, the ray aberration of the projection lens of in accordance with the present invention is negligibly minute, indicating excellent projection performance of the projection lens of the present invention.

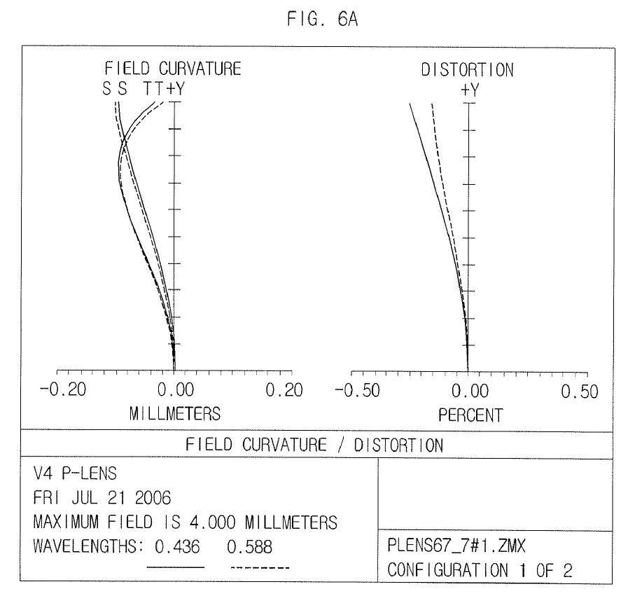

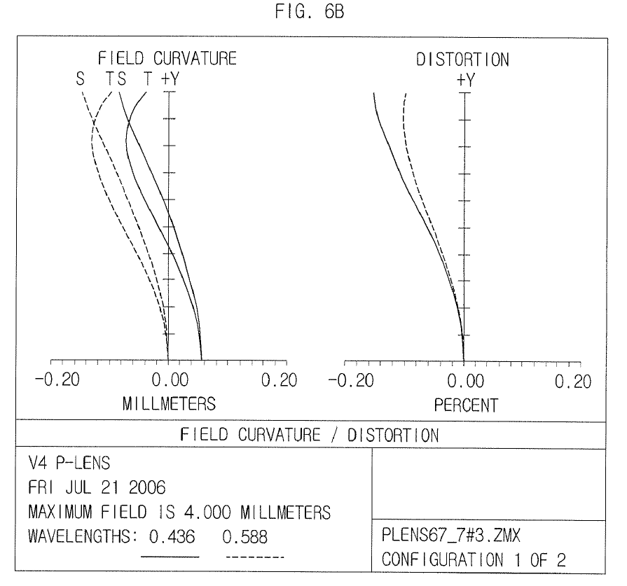

FIG. 6A illustrates field curvature and distortion aberration in the projection lens according to the actual implementation data of FIG. 3A. FIG. 6B illustrates field curvature and distortion aberration in the projection lens according to the actual implementation data of FIG. 3B.

Graphs shown on the left side of FIGS. 6A and 6B show field curvatures of the projection lens of the present invention. The field curvature shows a phenomenon in which the light having passed through the projection lens forms a curved image, rather than a flat image, on the screen 150. It can be understood in FIGS. 6A and 6B that the field curvature of the projection lens of the present invention is about 0.1 mm, demonstrating an outstanding performance of projection.

Graphs shown on the right side of FIGS. 6A and 6B show distortion aberrations of the projection lens of the present invention. The distortion aberration can be resulted from the change (difference) of magnification according to the position of a lens. For an ideal lens, the magnification remains constant throughout the lens, from the center toward the edge, that is, the curvature is constant. However, an actually manufactured lens may have different magnification for each position due to various factors such as an error in the manufacture and an incident direction (angle) of the modulated light. In other words, even though the modulated light is projected on the screen 150 through the projection lens, the distortion aberration may be generated owing to the difference of magnification according to position of the projection lens. In this case, when the distortion aberration is positive, each side of the screen looks concave. On the other hand, when the distortion aberration is negative, each side of the screen looks convex. The distortion aberration should be at least about ±2% in order for a person to recognize the distortion with naked eyes. Since the distortion aberration of the projection lens of FIGS. 6A and 6B in the present invention is within the range of about ±0.3%, the distortion aberration of the projection lens of the present invention is negligibly minute to be recognized by a person, demonstrating an outstanding performance of projection

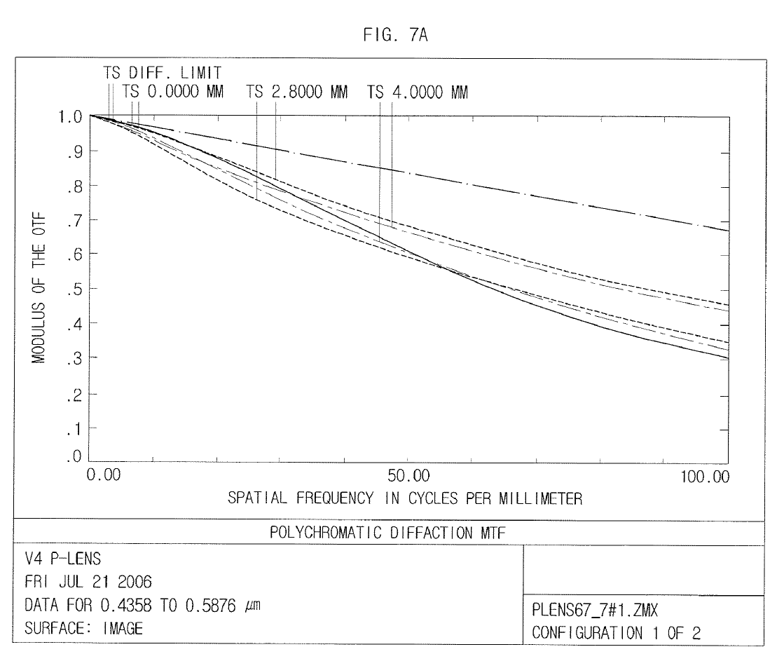

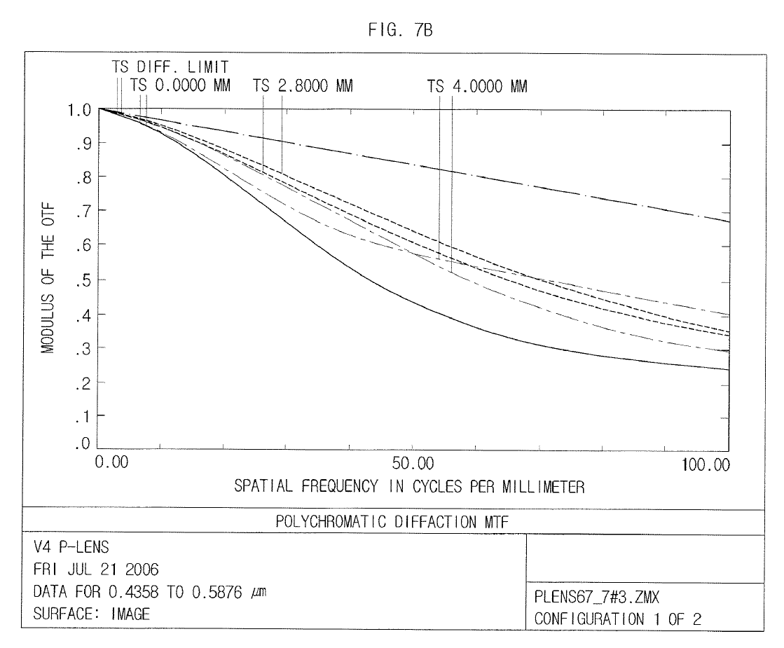

FIG. 7A is an illustration of MTF characteristics of the projection lens according to the actual implementation data of FIG. 3A. FIG. 7B is an illustration of MTF characteristics of the projection lens according to the actual implementation data of FIG. 3B.

FIGS. 7A and 7B illustrate Modulation Transfer Function (MTF) charts showing the performance of the projection lens of the present invention. In the MTF charts of FIGS. 7A and 7B, the X-axis represents spatial frequency, and the Y-axis represents contrast. The spatial frequency, expressed in units of lp/mm (line pair/mm), signifies the number of pairs of lines (constituted by a pair of one white line and one black line) included in the length of 1 mm on the optical modulator 100 or the screen 150. For example, when an interval of 200□ and five pairs of lines, each pair being one white line and one black line, are included in the length of 1 mm on the screen 150, the spatial frequency is 5 lp/mm. In the MTF chart, the contrast decreases with an increasing spatial frequency, because it is harder for human eyes to clearly distinguish the lines included in the length of 1 mm on the screen 150 as the number of pairs of lines included in the length of 1 mm on the optical modulator 100 or the screen 150 increases. That is, the MTF chart indicates the level in which human eyes are able to precisely recognize (distinguish) an image that has been magnified and projected on the screen 150 through the projection lens of the present invention with. Here, the MTF charts in FIGS. 7A and 7B illustrate the MTF characteristic on the optical modulator 100 instead of the screen 150.

Accordingly, referring to each of the MTF charts in FIGS. 7A and 7B, assuming that a contrast in which a person can generally distinguish an image on the screen 150 is about 0.3 (on the basis that the maximum contrast is 1), it can be understood that the spatial frequency of the modulated light on the optical modulator 100 corresponds to 100 lp/mm. Therefore, assuming that the magnification of the projection lens of the present invention is 20 times, the spatial frequency of the projected image on the screen 150 having a contrast of about 0.3 corresponds to about 5 lp/mm (i.e. 100 lp/mm×( 1/20)). That is, since the level where a person can actually distinguish the projected image on the screen 150 corresponds to five pairs of lines per a length of 1 mm, it can be noted that the projection lens of the present invention has an excellent performance of projection.

As described above, although the projection lens of the present invention is made simpler and smaller, the projection lens of the present invention has an excellent projection performance. Moreover, the projection lens of the present invention can be applied to a small-sized color display device such as a mobile terminal, PDA and PMP.

Although certain embodiments of the present invention have been described, it shall be evident to anyone of ordinary skill in the art that a large number of permutations or modifications are possible without departing from the technical ideas of the present invention, which shall be only defined by the appended claims.

What is claimed is:

1. A projection lens, configured to magnify and project inputted light on a screen, the projection lens comprising:
a first lens, configured to have a positive refractive power;
a second lens, configured to have a negative refractive power and receive the light that has passed through the first lens; and
a third lens, configured to be combined with the second lens to form a lens group having a positive refractive power and receive the light that has passed through the second lens and project the light on the screen separated by a predetermined length from the lens group.

2. The projection lens of claim 1, wherein the first lens receives light transmitted from an optical modulator, and the relation between a length (Bf) from a rear surface of the first lens to the optical modulator and a focal length (f) of the projection lens satisfies Bf>0.25f.

3. The projection lens of claim 1, wherein the relation between a projection distance (Pd) of the projection lens and the focal length (f) of the projection lens satisfies Pd>20f.

4. The projection lens of claim 1, wherein the relation between a field of view (Fov) of the projection lens and the focal length (f) of the projection lens satisfies Fov>0.4f.

5. The projection lens of claim 1, wherein an f-number (Fn) of the projection lens satisfies Fn>4.

6. The projection lens of claim 1, wherein the relation between a total length (T1) of the projection lens and the focal length (f) of the projection lens satisfies T1<1.42f.

7. The projection lens of claim 1, wherein the relation between a focal length (f_{G}) of the lens group and the focal length (f) of the projection lens satisfies 0.68<f/f_{G}<0.72.

8. The projection lens of claim 1, wherein the relation between a focal length (f₁) of the first lens and the focal length (f) of the projection lens satisfies 1.14<f/f₁<1.24.

9. The projection lens of claim 1, wherein an average value (N₃) of the index of refraction of the third lens satisfies 1.8<N₃<2.

10. The projection lens of claim 1, wherein an average value (V₃) of an Abbe number of the third lens satisfies 30<V₃<45.

11. A projection lens system, configured to magnify and project inputted light on a screen, the projection lens system comprising:
a projection lens; and
an aperture stop, located between the projection lens and the screen and configured to transmit light projected from the projection lens,
whereas the projection lens comprises:
a first lens, configured to have a positive refractive power;
a second lens, configured to have a negative refractive power and receive the light that has passed through the first lens; and
a third lens, configured to be combined with the second lens to form a lens group having a positive refractive power and receive the light that has passed through the second lens.

12. The projection lens system of claim 11, wherein the relation between an entrance pupil (Ep) of the aperture stop and a focal length (f) of the projection lens satisfies Ep>0.25f.
